(19) United States
(12) Patent Application Publication
(10) Pub. No.: US 2025/0116637 A1
(43) Pub. Date: Apr. 10, 2025

(54) HYDROGEN FLAME IONIZATION DETECTOR

(71) Applicant: SHIMADZU CORPORATION, Kyoto-shi (JP)

(72) Inventor: Ryosuke YAMAMOTO, Kyoto-shi (JP)

(21) Appl. No.: 18/907,228

(22) Filed: Oct. 4, 2024

(30) Foreign Application Priority Data
Oct. 10, 2023 (JP) 2023-175199

(51) Int. Cl. G01N 30/68; G01N 30/02

(52) U.S. Cl. CPC G01N 30/68; G01N 2030/025

(57) ABSTRACT

The present invention includes a housing (2) including an internal space (3) to which a combustion gas is supplied, a nozzle (4) provided with an ejection port (18) at an upper end, the nozzle (4) being configured to eject a mixed gas of a sample gas and a combustion support gas from the ejection port (18) to form a hydrogen flame at the upper end, and a collector (8) having a hollow cylindrical shape and provided above the nozzle (4) with a central axis facing a vertical direction to collect components in the sample gas ionized by a hydrogen flame formed at the upper end of the nozzle (4), wherein the nozzle (4) is provided with a first tapered surface (22) at an upper end part, the first tapered surface (22) being inclined with a first taper angle (θ1), the first tapered surface (22) reducing an outer diameter of the nozzle (4) toward the upper end, and the collector (8) is provided with a second tapered surface (24) inside a lower end part, the second tapered surface (24) being inclined with a second taper angle (θ2) larger than the first taper angle (θ1), the second tapered surface (24) reducing an inner diameter of the collector (8) upward from a lower end.

### BACKGROUND OF THE INVENTION

### 1. Field of the Invention

The present invention relates to a hydrogen flame ionization detector (hereinafter, also referred to as FID).

### 2. Description of the Related Art

FID is known as one of detectors in a gas chromatograph. In the FID, a sample gas in which a combustion support gas (hydrogen) and a makeup gas are mixed is ejected upward from a tip of a nozzle in a housing to which a combustion gas is supplied, a hydrogen flame is formed at an upper end of the nozzle to ionize components in the sample gas, and ions are collected by a collector provided above the nozzle, whereby the components in the sample gas are quantified (see JP 2000-206091 A).

### SUMMARY OF THE INVENTION

In the FID, as the distance between the nozzle and the collector is smaller, and as the nozzle is positioned deeper inside the collector, the collection efficiency of the collector for collecting the ions generated by the hydrogen flame improves, and the detection sensitivity improves. Meanwhile, a potential difference of about 100 to several 100 V is usually provided between the nozzle and the collector in order to improve the collection efficiency with the collector by directing the jumping direction of the ions generated by the hydrogen flame toward the collector side. Thus, the nozzle and the collector can be brought close to each other only to such an extent that the spatial insulation is not broken.

Further, the inner diameter of the collector is usually smaller than the maximum outer diameter of the nozzle, and thus it is difficult to cause the nozzle to enter the collector. As such, a structure may be adopted in which a tapered surface having the same taper angle as the tapered surface provided at an upper end part of the nozzle is provided on the inner surface of a lower end part of the collector. By adopting such a structure, not only the entry of the nozzle into the collector is facilitated, but also the combustion gas is guided to the vicinity of the upper end of the nozzle, which stabilizes the formation of the hydrogen flame at the upper end of the nozzle.

An object of the present invention is to improve the above structure and improve the ion collection efficiency with the collector while stabilizing the formation of the hydrogen flame at the upper end of the nozzle.

With the tapered surface of the inner surface of the lower end part of the collector having the same taper angle as the tapered surface of the upper end of the nozzle as in JP 2000-206091 A, when the nozzle has entered the collector too much, the gap between the nozzle and the collector becomes small, and the opening area for drawing the combustion gas into the collector becomes small. Then, the combustion gas is hardly guided to the vicinity of the upper end of the collector, and the formation of the hydrogen flame may become unstable. The present invention provides a hydrogen flame ionization detector having a structure in which an opening area for drawing a combustion gas into a collector is secured even when a nozzle has entered the collector.

That is, an FID according to the present invention includes a housing including an internal space to which a combustion gas is supplied, a nozzle provided with an ejection port at an upper end, the nozzle being configured to eject a mixed gas of a sample gas and a combustion support gas from the ejection port to form a hydrogen flame at the upper end, and a collector having a hollow cylindrical shape and provided above the nozzle with a central axis facing a vertical direction to collect components in the sample gas ionized by a hydrogen flame formed at the upper end of the nozzle, wherein an outer peripheral surface of an upper end part of the nozzle is inclined with a first taper angle, the outer peripheral surface reducing an outer diameter of the nozzle toward the upper end, and the collector is provided with a tapered surface inside a lower end part, the tapered surface being inclined with a second taper angle larger than the first taper angle, the tapered surface reducing an inner diameter of the collector upward from a lower end.

In the FID according to the present invention, the outer peripheral surface of the upper end part of the nozzle is inclined with a first taper angle, the outer peripheral surface reducing the outer diameter of the nozzle toward the upper end, and the collector is provided with a tapered surface inside a lower end part, the tapered surface being inclined with a second taper angle larger than the first taper angle, the tapered surface reducing the inner diameter of the collector upward from the lower end. Thus, the FID can secure the opening area for drawing the combustion gas into the collector even when the nozzle has entered the collector, which can improve the ion collection efficiency of the collector while stabilizing the formation of the hydrogen flame at the upper end of the nozzle.

### BRIEF DESCRIPTION OF THE DRAWINGS

FIG. 1 is a sectional view illustrating an internal structure of an example of an FID;

FIG. 2 is a view for describing a relationship between the taper angle of a tapered surface of a nozzle and the taper angle of a tapered surface of a collector in the example;

FIG. 3 is a view illustrating a case where the taper angle of a tapered surface of a nozzle is the same as the taper angle of a tapered surface of a collector as a comparative example; and

FIG. 4 is a view illustrating a case where no tapered surface is provided on an inner surface of a lower end part of a collector as a comparative example.

### DETAILED DESCRIPTION OF THE INVENTION

Hereinafter, an example of an FID according to the present invention will be described with reference to the drawings.

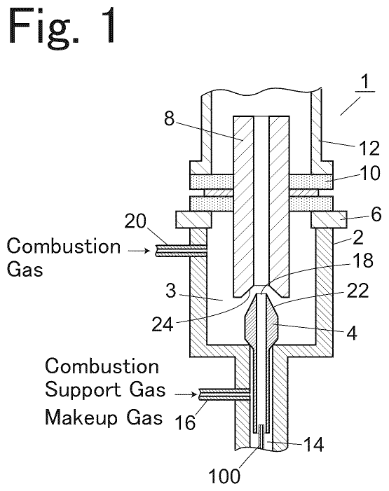

FIG. 1 illustrates an internal sectional structure of the example of the FID.

An FID 1 includes a lower housing 2, a nozzle 4, a collector holding member 6, a collector 8, an insulator 10, and an upper housing 12.

The lower housing 2 is a hollow cylindrical member having an open upper surface. The lower housing has an internal space 3. A combustion gas is supplied to the internal space 3 of the lower housing 2 through a pipe 20. The lower housing 2 is provided with a hole 14 communicating with the internal space 3 at a lower part facing a vertical direction.

The nozzle 4 is attached to the lower housing 2 in a state where an upper part of the nozzle 4 protrudes upward from the hole 14. The nozzle 4 includes an ejection port 18 at the upper end, and the downstream end of a separation column 100 of a gas chromatograph is inserted into the lower end. A combustion support gas (hydrogen) and a makeup gas are supplied into the hole 14 through a pipe 16. The combustion support gas and the makeup gas supplied into the hole 14 go around the lower end of the nozzle 4 and enter the nozzle 4 through the gap between the nozzle 4 and the separation column 100, are mixed with the sample gas from the separation column 100, and are ejected upward from the ejection port 18 of the nozzle 4.

The lower housing 2 is attached with a collector holding member 6 at an upper part, and the upper housing 12 is attached on the collector holding member 6 with two insulators 10 interposed between the collector holding member and the upper housing. Although not illustrated, an igniter for forming a hydrogen flame at the tip of the nozzle 4 is provided in the upper housing 12. Each of the two insulators 10 is a disk-shaped insulating member that holds the outer peripheral surface of the collector 8.

The collector 8 is a hollow cylindrical member with both ends opened, and the insulator 10 is attached to the outer peripheral surface of the collector 8 so as to spread in the circumferential direction from the outer periphery of the collector 8. The peripheral edge of the insulator 10 is sandwiched between the collector holding member 6 and the upper housing 12, and thus the collector 8 is disposed above the nozzle 4 such that its axial direction faces a vertical direction. The collector 8 is an electrode for collecting ions generated by the hydrogen flame formed at the tip of the nozzle 4.

The outer peripheral surface 22 of an upper end part of the nozzle 4 is inclined so that the outer diameter becomes smaller toward the upper end to form a first tapered surface (hereinafter, referred to as first tapered surface 22). The outer diameter of the nozzle 4 is minimum at the upper end part. The inner surface 24 of a lower end part of the collector 8 is inclined so that the inner diameter becomes larger toward the lower end to form a second tapered surface (hereinafter, referred to as second tapered surface 24). The inner diameter of the main part above the upper end of the second tapered surface 24 of the collector 8 is smaller than the outer diameter of the maximum outer diameter part of the nozzle 4.

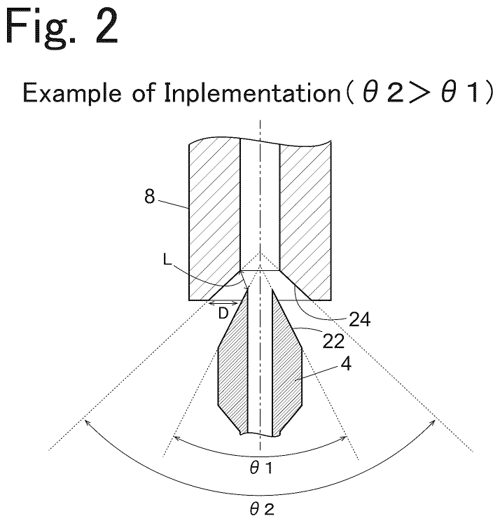

As illustrated in FIG. 2, a taper angle θ2 (second taper angle) of the second tapered surface 24 of the collector 8 is larger than a taper angle θ1 (first taper angle) of the first tapered surface 22 of the nozzle 4, and the inner diameter of the lower end of the collector 8 is larger than the outer diameter of the upper end of the nozzle 4.

The upper end of the nozzle 4 is positioned above the lower end of the collector 8. The upper end has entered the collector 8. As the distance between the nozzle 4 and the collector 8, a distance L between the upper end of the nozzle 4 and the upper end of the second tapered surface 24 of the collector 8 is minimum. The distance L is designed to a size that does not break the spatial insulation between the nozzle 4 and the collector 8.

Here, the taper angle θ2 of the second tapered surface 24 of the collector 8 only needs to be larger than the taper angle θ1 of the tapered surface 22 of the nozzle 4. However, the taper angle θ2 needs to be large enough to achieve an effect of guiding the combustion gas in the internal space 3 to the inside of the collector 8, that is, to the vicinity of the upper end of the nozzle 4. Thus, it does not mean that the larger the taper angle θ2, the better. A size of the taper angle θ2 as close as possible to 180° is not favorable. For example, θ2 can be set to about θ1+30 degrees, and when the taper angle θ1 is 60 to 90°, the taper angle θ2 may be 90 to 120°.

Having the taper angle θ2 of the second tapered surface 24 of the collector 8 larger than the taper angle θ1 of the first tapered surface 22 of the nozzle 4 makes it possible to widen the interval D between the lower end of the collector 8 and the nozzle 4 even when the upper end of the nozzle 4 has entered the collector 8. When the interval D between the lower end of the collector 8 and the nozzle 4 is wide, an opening area for drawing the combustion gas in the internal space 3 into the collector 8 is sufficiently secured, and the hydrogen flame formed at the upper end of the nozzle 4 is stabilized. That is, appropriately increasing the taper angle θ2 of the second tapered surface 24 of the collector 8 with respect to the taper angle θ1 of the first tapered surface 22 of the nozzle 4 makes it possible to achieve both an improvement in the ion collection efficiency by causing the upper end of the nozzle 4 to enter the collector 8 and the nozzle 4 to approach the collector 8 and the stabilization of the hydrogen flame by guiding the combustion gas to the vicinity of the upper end of the nozzle 4.

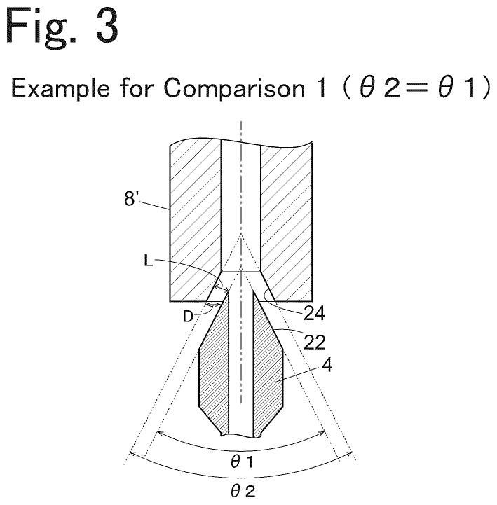

FIG. 3 illustrates, as Comparative Example 1, a case of using a collector 8′ in which the taper angle θ2 is the same as the taper angle θ1 of the nozzle 4. Also in a case where the taper angle θ2 is the same as the taper angle θ1 like in Comparative Example 1, the upper end of the nozzle 4 can enter the collector 8′ to some extent. However, since the taper angle θ2 of the collector 8′ is the same as the taper angle θ1 of the nozzle 4, the distance L between the nozzle 4 and the collector 8′ in a perpendicular direction of the first and second tapered surfaces 22 and 24 is the shortest, and thus there is a limit in allowing the nozzle 4 to enter the collector 8′ in consideration of spatial insulation between the nozzle 4 and the collector 8′. In addition, since the taper angle θ2 of the collector 8′ is the same as the taper angle θ1 of the nozzle 4, when the shortest distance L between the nozzle 4 and the collector 8′ is reduced, the interval D between the lower end of the collector 8′ and the nozzle 4 is also reduced, and the opening area for drawing the combustion gas to the inside of the collector 8 is reduced.

When the structure of FIG. 2 and the structure of FIG. 3 are compared to each other as described above, it can be seen that both the improvement in the ion collection efficiency and the stabilization of the hydrogen flame can be easily achieved by making the taper angle θ2 larger than the taper angle θ1 as compared with the case where the taper angle θ2 and the taper angle θ1 are the same.

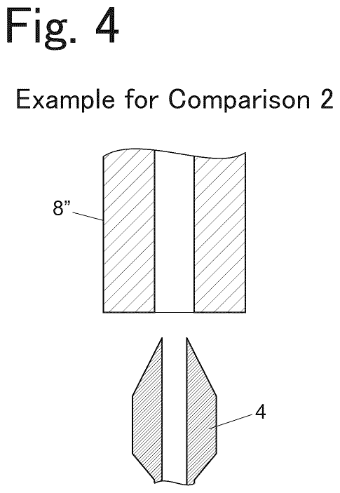

FIG. 4 illustrates a case where a collector 8″ having no tapered surface on the inner surface of the lower end part is used as Comparative Example 2. When the collector 8″ having no tapered surface on the inner surface of the lower end is used as in Comparative Example 2, the effect of drawing the combustion gas into the vicinity of the upper end of the nozzle 4 is not obtained, and the nozzle 4 cannot enter the collector “, thus the effect of improving the ion collection efficiency with the collector 8” cannot be obtained.

The example described above is merely an example of the embodiments of the FID according to the present invention. The embodiments of the FID according to the present invention are as follows.

An embodiment of the FID according to the present invention includes a housing including an internal space to which a combustion gas is supplied, a nozzle provided with an ejection port at an upper end, the nozzle being configured to eject a mixed gas of a sample gas and a combustion support gas from the ejection port to form a hydrogen flame at the upper end, and a collector having a hollow cylindrical shape and provided above the nozzle with a central axis facing a vertical direction to collect components in the sample gas ionized by a hydrogen flame formed at the upper end of the nozzle, wherein the nozzle is provided with a first tapered surface at an upper end part, the first tapered surface being inclined with a first taper angle, the first tapered surface reducing an outer diameter of the nozzle toward the upper end, and the collector is provided with a second tapered surface inside a lower end part, the second tapered surface being inclined with a second taper angle larger than the first taper angle, the second tapered surface reducing an inner diameter of the collector upward from a lower end.

In the aspect [1] of the embodiment, the upper end of the nozzle is disposed at a position higher than the lower end of the collector. With such an aspect, the ejection port of the nozzle is positioned inside the collector, and thus the ions generated by the hydrogen flame formed at the upper end of the nozzle are less likely to scatter in the circumferential direction, which improves the collection efficiency of the ions with the collector.

In the aspect [2] of the embodiment, as a distance between the nozzle and the collector, a distance between the upper end of the nozzle and an upper end of the second tapered surface of the collector is minimum. With such an aspect, entry of the nozzle into the collector is facilitated, and the collection efficiency of ions with the collector can improve.

### DESCRIPTION OF REFERENCE SIGNS

1 FID (hydrogen flame ionization detector)
2 Lower housing
3 Internal space
4 Nozzle
6 Collector holding member
8 Collector
10 Insulator
12 Upper housing
14 Hole
16, 20 Pipe
18 Ejection port
22 First tapered surface
24 Second tapered surface

What is claimed is:

1. A hydrogen flame ionization detector comprising:
a housing including an internal space to which a combustion gas is supplied;
a nozzle provided with an ejection port at an upper end, the nozzle being configured to eject a mixed gas of a sample gas and a combustion support gas from the ejection port to form a hydrogen flame at the upper end; and
a collector having a hollow cylindrical shape and provided above the nozzle with a central axis facing a vertical direction to collect components in the sample gas ionized by a hydrogen flame formed at the upper end of the nozzle,
wherein the nozzle is provided with a first tapered surface at an upper end part, the first tapered surface being inclined with a first taper angle, the first tapered surface reducing an outer diameter of the nozzle toward the upper end, and
the collector is provided with a second tapered surface inside a lower end part, the second tapered surface being inclined with a second taper angle larger than the first taper angle, the second tapered surface reducing an inner diameter of the collector upward from a lower end.

2. The hydrogen flame ionization detector according to claim 1, wherein the upper end of the nozzle is disposed at a position higher than the lower end of the collector.

3. The hydrogen flame ionization detector according to claim 1, wherein as a distance between the nozzle and the collector, a distance between the upper end of the nozzle and an upper end of the second tapered surface of the collector is minimum.
